(19) United States
(12) Patent Application Publication
(10) Pub. No.: US 2018/0110236 A1
(43) Pub. Date: Apr. 26, 2018

(54) HUMAN POWERED BEVERAGE-MAKING APPARATUS

(71) Applicant: Joseph Donoughe, Lake Mary, FL (US)

(72) Inventor: Joseph Donoughe, Lake Mary, FL (US)

(21) Appl. No.: 15/331,804

(22) Filed: Oct. 21, 2016

(51) Int. Cl. A23G 9/04; A23G 9/28; B67D 1/16; B67D 1/08; B67D 1/00; A63B 22/02

(52) U.S. Cl. CPC A23G 9/045; A23G 9/28; A63B 22/02; B67D 1/0894; B67D 1/0003; B67D 1/16

(57) ABSTRACT

A human powered beverage-making apparatus powered by a user for providing an iced beverage includes a frame member, a hollow cylindrical wheel, an ice dispenser assembly, a conveyor assembly, and a beverage dispensing assembly. The frame member accommodates a hollow cylindrical wheel. The hollow cylindrical wheel is rotatably mounted on roller assemblies positioned on the frame member. The user rotates the hollow cylindrical wheel to generate a rotary drive. The ice dispenser assembly is attached to the frame member and positioned above a conveyor assembly. The ice dispenser assembly includes a drive plate rotatable by the rotary drive to dispense ice shavings into a container positioned on the conveyor assembly. The conveyor assembly is driven by multiple manual crank drives to convey a cup to the ice dispensing assembly, then to the compaction assembly, and then the filled container to a beverage dispensing assembly. The beverage dispensing assembly selectively dispenses one or more beverages into the filled container to provide the iced beverage.

### TECHNICAL FIELD OF THE INVENTION

The invention disclosed herein generally relates to running wheels or human size hamster wheels. More particularly, the invention relates to a human powered beverage-making apparatus for providing an iced beverage.

### BACKGROUND

Running wheels or hamster wheels refer to exercise devices intended primarily for rodents or hamsters. However, with most jobs requiring employees to work for long hours in a seated position, running wheels have been designed to provide adequate exercise. These running wheels may be installed at workplaces or homes based on the preference of the user. Although running wheels may be installed anywhere, existing running wheels require skilled personnel for installation. Additionally, they are not portable in nature. A running wheel, which could be easily installed and is portable, is required. Moreover, running wheels may be used at parks or for recreational activities at parties for children and adults alike. A running wheel or a hamster wheel in itself seems monotonous and unattractive. Accordingly, using the running wheel to create beverages, ice creams, etc., attract individuals of all ages. This ensures the individual exerts himself or herself and eventually converts his or her exertion into a tangible product. An attachment or added capability to a running wheel, which increases the involvement and amusement of both adults and kids alike, is required.

Hence, there is a long felt but unresolved need for a running wheel, which is easily installed and is portable. Furthermore, there is a need for an attachment or added capability to a running wheel, which increases the involvement of both adults and kids alike who use it.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The human powered beverage-making apparatus, disclosed herein, addresses the above-mentioned need for a running wheel, which is easily installed and is portable. Furthermore, the invention addresses the need for an attachment or added capability to a running wheel, which increases the involvement of both adults and kids alike who use it. A human powered beverage-making apparatus powered by a user for providing an iced beverage comprises a frame member, a hollow cylindrical wheel, an ice dispenser assembly, a conveyor assembly, and a beverage dispensing assembly. The frame member accommodates a hollow cylindrical wheel. The hollow cylindrical wheel is rotatably mounted on roller assemblies positioned on the frame member. The user, running inside the hollow cylindrical wheel, rotates the hollow cylindrical wheel to generate a rotary drive. The ice dispenser assembly is attached on a side of the frame member. Additionally, the ice dispenser assembly is aligned vertically above a conveyor assembly. The ice dispenser assembly comprises a drive plate rotatable by the rotary drive received from the user driven hollow cylindrical wheel to dispense ice shavings into a container positioned on the conveyor assembly. The conveyor assembly is positioned on the frame member substantially in front of the user. The conveyor assembly is configured to be driven by a manual crank drive to convey the filled container to a beverage dispensing assembly. The beverage dispensing assembly is positioned at an end of the conveyor assembly. The beverage dispensing assembly is configured to selectively dispense one or more beverages into the ice shavings filled container to provide the iced beverage.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a right perspective view of a human powered beverage-making apparatus.

FIG. 2 exemplarily illustrates a right perspective view of a human powered beverage-making apparatus.

FIG. 3 exemplarily illustrates a side elevation view of a human powered beverage-making apparatus.

### DETAILED DESCRIPTION OF THE INVENTION

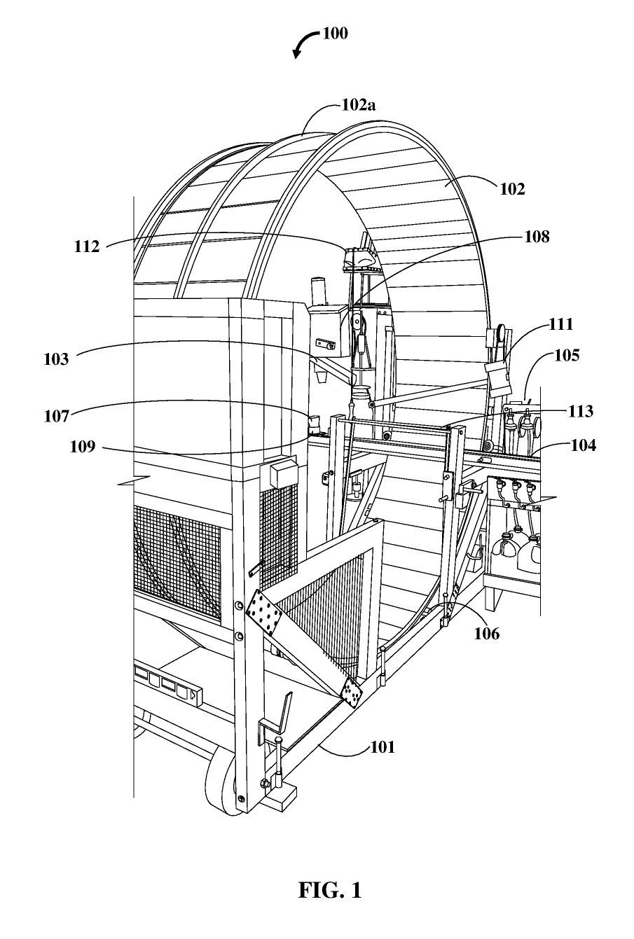

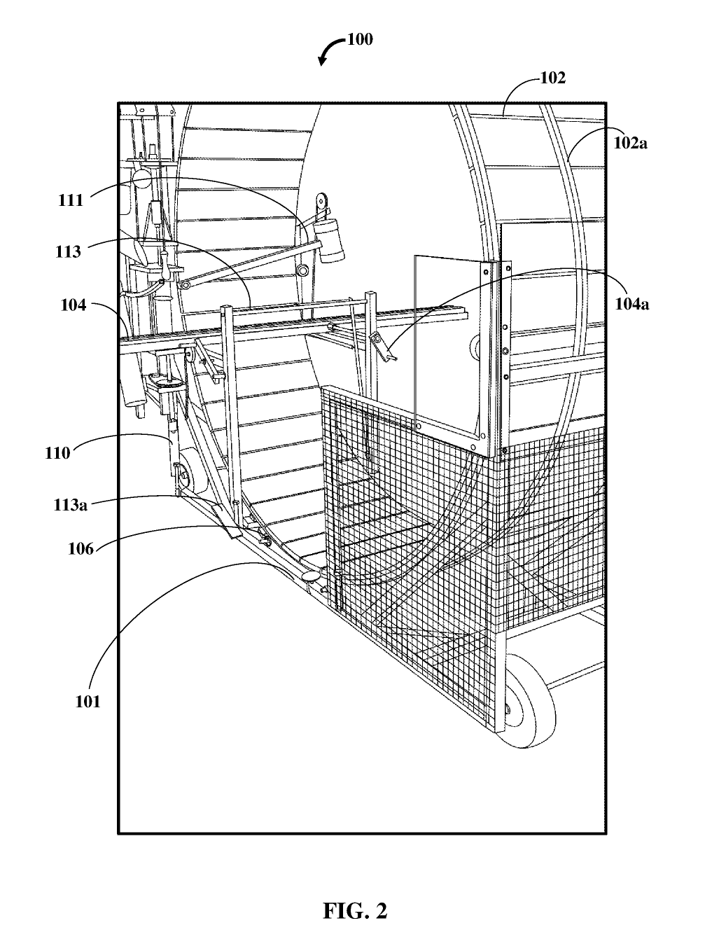

FIG. 1 exemplarily illustrates a perspective view of a human powered beverage-making apparatus 100. FIG. 2 exemplarily illustrates a right perspective view of a human powered beverage-making apparatus. The human powered beverage-making apparatus 100 powered by a user for providing an iced beverage comprises a frame member 101, a hollow cylindrical wheel 102, an ice dispenser assembly 103, a conveyor assembly 104, and a beverage dispensing assembly 105. In an embodiment, the human powered beverage-making apparatus 100 is about 8 ft. tall, and produces frozen beverages, for example, snow cones, adult beverages, etc. The human powered beverage-making apparatus 100 is completely driven by the individual, that is, no external power source is required to run the human powered beverage-making apparatus 100. The frame member 101 is configured to accommodate a hollow cylindrical wheel 102. In an embodiment, the frame member 101 comprises, for example, eight adjustable levelers, a level bubble, skid plates, safety fencing, shelving, and self-contained 8-inch casters on shafts for transporting. The hollow cylindrical wheel 102 is rotatably mounted on roller assemblies 106 positioned on the frame member 101. In an embodiment, the hollow cylindrical wheel 102 comprises wood planks mounted to curved square metal tubing, which eliminates the need for a center hub or spokes.

The human powered beverage making-apparatus 100 also comprises a separate, detached sub assembly, consisting of an axle and two 8-inch wheels, which inserts in to the frame member 101 for transporting use only. This feature allows the human powered beverage making-apparatus 100 to be portable. In an embodiment, the roller assemblies 106 are positioned about 180 degrees apart on the hollow cylindrical wheel 102. The hollow cylindrical wheel 102 is constructed of two semi circles, aligned by tabs protruding from the rim of the hollow cylindrical wheel 102 and secured together by a center band 102a that bolts together for ease of assembly and assured safety. In an embodiment, the roller assemblies 106 comprise about five sets of metal rollers with bearings, bearing holders, and a shaft. A one-way clutch roller assembly comprising clutch bearings, roller, keyways, keyed shaft prevents the hollow cylindrical wheel 102 from rotating backwards. The user, running inside the hollow cylindrical wheel 102, rotates the hollow cylindrical wheel 102 to generate a rotary drive. The ice dispenser assembly 103 is attached on a side of the frame member 101. The ice dispenser assembly 103 is aligned vertically above the conveyor assembly 104. The ice dispenser assembly 103 comprises a drive plate rotatable by the rotary drive received from the user driven hollow cylindrical wheel 102 to dispense ice shavings into a container 107 positioned on the conveyor assembly 104.

The conveyor assembly 104 is positioned on the frame member 101 substantially in front of the user. The conveyor assembly 104 is driven by a manual crank drive 104a to convey the filled container 107 to a beverage dispensing assembly 105 as exemplarily illustrated in FIG. 2. In an embodiment, multiple manual crank drives 104a are positioned at multiple locations of the human powered beverage-making apparatus 100. In an embodiment, the conveyor assembly 104 is chain driven. The beverage dispensing assembly 105 is positioned at an end of the conveyor assembly 104. The beverage dispensing assembly 105 selectively dispenses one or a combination of beverages into the ice shavings filled container 107 to provide the iced beverage. In an embodiment, the conveyor assembly 104 comprises a drip tray for collecting misdirected ice shavings and other liquids. In an embodiment, the chain driven, manually powered, conveyor assembly 104 is segmented into three sections. The segmented chain permits indirect manually powered transfer of the cup holder, which automatically positions the container 107 at the next operation. In an embodiment, the container 107 is, for example, a disposable cup, etc. In an embodiment, the beverage dispensing assembly 105 comprises a juice cabinet, casters, multiple individual dispensing heads which are manually pressurized via a lever and springs or rubber bands, check valves to regulated fluid direction, filters, on/off valves, and graduated cylinders and plungers by which to accurately measure the dispensing fluid.

By changing the spring/rubber band tension on the fluid dispenser, it allows the transfer of a combination of viscous fluids. The fluid dispensing heads dispense pre mixed beverages, as in adult beverages, or the ingredients remain separate, and are dispensed via independent dispensers. The conveyor assembly 104 is segmented into three sections for two reasons. One was to stop the cup at the precise location for the next operation to be performed. The other reason is so that the human powered beverage-making apparatus 100 is used in an assembly line fashion, allowing a person to be running in the hollow cylindrical wheel 102 grinding ice, while another is at the start location, and another person is applying beverage to their container 107 at another end of the conveyor assembly 104. This aids in the through put time, allowing users to have three containers 107 in operation simultaneously, therefore increasing sales. Moreover, the human powered beverage-making apparatus 100 comprises an insulated ice storage bin 108. In an embodiment, the ice storage bin 108 manually feeds ice to the ice dispenser assembly 103 via a manually operated crank handle, which drives an auger inside the ice storage bin 108, to dispense gravity fed ice down a clear plastic chute into the ice dispenser assembly 103.

The ice dispenser assembly 103 comprises a housing, a steel blade, a drive plate, an ice-dispensing chute, and a lever and cable system. The housing of the ice dispenser assembly 103 receives the dispensed ice from the ice storage bin 108. The lever and cable system raises and lowers the drive plate. The steel blade finely cuts or shaves the dispensed ice. A belt driven gear reduction pulley rotates the drive plate to rotate the ice over the steel blade. The belt driven gear reduction pulley simultaneously rotates the container 107 during the ice shaving process. The ice shavings are dispensed through the ice-dispensing chute into the container 107 positioned on an adjustable container holder 109 that rests on a trolley platform. In an embodiment, the adjustable container holder 109 is fitted with a magnet to aide in alignment and stability when mated with the container lifting assembly 110 as exemplarily illustrated in FIG. 2. The human powered beverage-making apparatus 100 also comprises an ice compactor 111 for compacting the ice shavings filled container 107. The ice compactor 111 comprises a crank handle, a linkage, a lever, and a compactor.

The human powered beverage-making apparatus 100 also comprises a manually operated pneumatic horn 112 that is activated via a rope for indicating motion of the hollow cylindrical wheel 102 as exemplarily illustrated in FIG. 1. The human powered beverage-making apparatus 100 comprises a deceleration assembly 113 for decelerating the hollow cylindrical wheel 102. The deceleration assembly 113 comprises a manually operated independent brake pad, brake pad trough, and lever as exemplarily illustrated in FIGS. 1-2. In an embodiment, the deceleration assembly 113 also comprises an emergency brake pedal 113a, exemplarily illustrated in FIG. 2. The emergency brake pedal 113a is used to brake or decelerate the hollow cylindrical wheel 102 if needed. The emergency brake pedal 113a is used if the user is operating in an unsafe manner, for example, too fast, too reckless, etc. The individual places their container 107 in an adjustable container holder 109 that is at rest on a 7-ft long, segmented, chain driven conveyor assembly 104. The adjustable container holder 109 has a removable insert to allow the use of various size cups. The chain driven conveyor assembly 104 is segmented into three independently controlled sections. The first section of the conveyor assembly 104 advances the container 107, via the customer manually cranking a handle, which is directly attached to the conveyor assembly 104, to the first operation. The container 107 automatically stops in the correct position due to the void in the segmented track. Here, a lever is flipped to separate the adjustable container holder 109 from the trolley, raising the container 107 upward to make contact with the ice-dispensing chute.

The adjustable container holder 109 is perfectly located and held in place via magnets. The magnet also locks the adjustable container holder 109 in place to prevent the container 107 from tipping. A lever located on the frame member 101 is then lowered to raise the ice shaving drive plate. Ice is added to the ice dispenser assembly 103 via the crank attached to an auger of the ice storage bin 108. A manually operated pneumatic horn 112 is then activated to announce that the hollow cylindrical wheel 102 is about to go in motion. The individual then enters the hollow cylindrical wheel 102 of the human powered beverage-making apparatus 100. The individual deactivates a manual brake similar to what can be found on a push lawnmower. The individual starts walking, which causes the container 107 to rotate as the ice simultaneously shaves itself via the ice dispenser assembly 103. The rotating container 107 aides in dispensing the ice evenly within the container 107. When the container 107 has filled to the point that the ice mounds well above the height of the container 107. The container 107 is lowered via a handle, then another crank advances the container 107 further down the conveyor assembly 104 to the next operation.

The container 107 stops automatically, when positioned vertically below the ice dispenser assembly 103. The individual then activates a lever to cause an ice compactor 111 to smash the ice into the container 107 tempering the top layer of ice. The individual then exits the hollow cylindrical wheel 102 and cranks another handle to advance the container 107 to the beverage dispensing assembly 105 of the conveyor assembly 104. The individual locates their container 107, via crank, to their desired flavor. Next, an individual pulls an independent lever to dispense the desired beverage amount to exact quantity. This method controls not only the quantity of fluid, but also the possible release of fluids from adjacent dispensers if the individual activates the incorrect dispenser. The individual then pushes a button or lever to activate the flow of the beverage, via showerheads, to the container 107. Finally, the drink is then advanced further down the conveyor assembly 104.

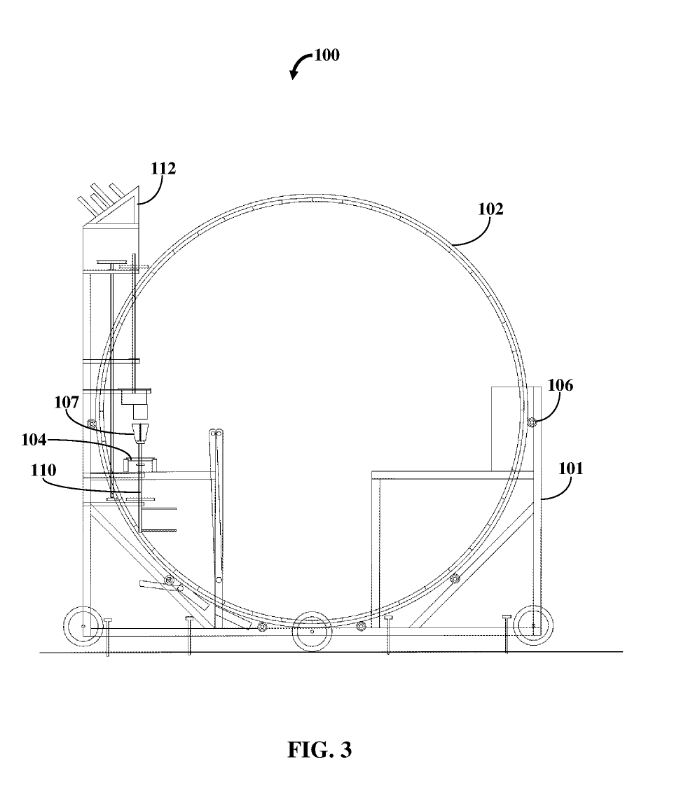

FIG. 3 exemplarily illustrates a side elevation view of a human powered beverage-making apparatus 100. In an embodiment, the human powered beverage-making apparatus 100 is designed to enter through a standard door way and reassembled. The hollow cylindrical wheel 102 is constructed of two semi circles, aligned by tabs protruding from the rim of the hollow cylindrical wheel 102 and secured together by a center band 102a that bolts together for ease of assembly and assured safety. The beverage dispensing assembly 105 was designed to control the exacting quantity of fluid and to prevent unauthorized use when not properly activated. A set of clutch bearings used in the roller assemblies 106 supports the hollow cylindrical wheel 102 and prevents the user from rotating the hollow cylindrical wheel 102 in the wrong direction. This feature prevents the unsafe feeling of traveling backwards. A brake prevents the hollow cylindrical wheel 102 from spinning if not deactivated by the user. Multiple guide wheels, located on the frame member 101, track the hollow cylindrical wheel 102 alignment. In an embodiment, the roller assemblies 106 are located 180 degrees apart, and aligned with the horizon, keeping the spoke-less, hub-less hollow cylindrical wheel 102 concentric.

Without this feature, the hollow cylindrical wheel 102 would not maintain its true shape. In an embodiment, 8-inch wheels are permanently installed at four locations to transport the hollow cylindrical wheel 102 to the site of use. An additional axle with 8-inch wheels can be added to the frame member 101 of the human powered beverage-making apparatus 100. This allows the human powered beverage-making apparatus 100 to travel around tight corners during installation. They are removed during normal use. In an embodiment, the frame member 101 comprises leveling legs at about eight locations. The human powered beverage-making apparatus 100 also comprises a manually operated pneumatic horn 112 that is activated via a rope for indicating motion of the hollow cylindrical wheel 102 as exemplarily illustrated in FIG. 1. The pneumatic horn 112 was installed to draw attention to the motion of the hollow cylindrical wheel 102. In an embodiment, the entire assembly fits on a 4 ft×8 ft flatbed trailer or an enclosed 5 ft×8 ft enclosed trailer with a door opening of approx. 5 ft tall and 4 ft wide. Installation of the human powered beverage-making apparatus 100 is quick and is completed by an individual in about 30 minutes.

The foregoing examples have been provided merely for the purpose of explanation and are in no way to be construed as limiting of the human powered beverage making-apparatus 100, disclosed herein. While the human powered beverage making-apparatus 100 has been described with reference to various embodiments, it is understood that the words, which have been used herein, are words of description and illustration, rather than words of limitation. Further, although the human powered beverage making-apparatus 100, has been described herein with reference to particular means, materials, and embodiments, the human powered beverage making-apparatus 100 is not intended to be limited to the particulars disclosed herein; rather, the human powered beverage making-apparatus 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the human powered beverage making-apparatus 100 disclosed herein in their aspects.

What is claimed is:

1. A human powered beverage-making apparatus powered by a user for providing an iced beverage, the human powered beverage-making apparatus comprising:
a frame member configured to accommodate a hollow cylindrical wheel, wherein the hollow cylindrical wheel is rotatably mounted on a plurality of roller assemblies positioned on the frame member, wherein the hollow cylindrical wheel is rotated by the user, running inside the hollow cylindrical wheel, to generate a rotary drive;
an ice dispenser assembly attached on a side of the frame member and aligned vertically above a conveyor assembly, wherein the ice dispenser assembly comprises a drive plate rotatable by the rotary drive received from the user driven hollow cylindrical wheel to dispense ice shavings into a container positioned on the conveyor assembly;
the conveyor assembly positioned on the frame member substantially in front of the user, the conveyor assembly configured to be driven by a manual crank drive to convey an empty cup to the ice dispensing assembly, the filled container to a compaction assembly, and then the beverage dispensing assembly; and
the beverage dispensing assembly positioned at an end of the conveyor assembly, the beverage dispensing assembly configured to selectively dispense one or more beverages into the ice shavings filled container to provide the iced beverage.

2. The human powered beverage-making apparatus of claim 1, further comprising a deceleration assembly for decelerating the hollow cylindrical wheel.

3. The human powered beverage-making apparatus of claim 1, further comprising an ice compactor for compacting the ice shavings filled container.

4. The human powered beverage-making apparatus of claim 1, further comprising a manually operated pneumatic horn for indicating motion of the hollow cylindrical wheel.

5. The human powered beverage-making apparatus claim 1, wherein the conveyor assembly is chain driven.

6. The human powered beverage-making apparatus of claim 1, wherein the conveyor assembly comprises a drip tray for collecting misdirected ice shavings and other liquids.

7. The human powered beverage-making apparatus of claim 1, wherein the roller assemblies are positioned about 180 degrees apart on the hollow cylindrical wheel.

8. The human powered beverage-making apparatus of claim 1, wherein the container is a cup.

9. The human powered beverage-making apparatus of claim 1, wherein the container is disposable.

10. The human powered beverage-making apparatus of claim 1, wherein the cup holder is magnetic.

11. The human powered beverage-making apparatus of claim 1, wherein the cup holder is adjustable to hold containers of varying dimensions.
